(19) United States
(12) Patent Application Publication
(10) Pub. No.: US 2024/0390820 A1
(43) Pub. Date: Nov. 28, 2024

(54) DEFOAMING AGENT AND COMPOSITIONS CONTAINING THE DEFOAMING AGENT

(71) Applicant: SOLENIS TECHNOLOGIES, L.P., Wilmington, DE (US)

(72) Inventors: Are Wiberg, Kempen (NO); Jose Antonio Pinilla Sanchez, Barcelona (ES); James William Martin, Bonaire, GA (US)

(73) Assignee: SOLENIS TECHNOLOGIES, L.P., Wilmington, DE (US)

(21) Appl. No.: 18/673,360

(22) Filed: May 24, 2024

Related U.S. Application Data
(60) Provisional application No. 63/504,206, filed on May 25, 2023.

(51) Int. Cl. B01D 19/04; C02F 1/20; C02F 103/28; C08G 77/14; C08K 3/36; C08K 5/05; C08K 5/103; C08K 13/02; D21C 11/00

(52) U.S. Cl. CPC B01D 19/0409; C02F 1/20; C08G 77/14; C08K 13/02; D21C 11/0085; C02F 2103/28; C08K 3/36; C08K 5/05; C08K 5/103; C08K 2201/014

(57) ABSTRACT

A method of treatment of an aqueous foamable medium, such as a process stream of a pulp and paper mill, the method comprising contacting the aqueous process stream with a defoaming agent comprising: a) at least one C₁₂ to C₄₀ Guerbet alcohol; and/or, b) at least one polyol ester.

### TECHNICAL FIELD

This disclosure relates to defoamers which may have particular utility for pulp and paper mill applications and which are based on bio-renewable materials. More particularly, the present disclosure is directed to the use of at least one compound selected from the group consisting of polyol esters and C₁₈-C₃₆ Guerbet alcohols as a defoaming agent in pulp and paper mill applications.

### BACKGROUND

Within a pulp and paper mill it is considered that four main factors contribute to the generation of foam: the presence of an air source; the employment of a low viscosity, liquid medium, more particularly an aqueous medium; the mechanical energy imparted to the liquid medium in the presence of said air source; and, the presence of chemical compounds-surface active agents-within the liquid medium which are conducive to the formation of a foam and the stabilization thereof.

It will be recognized that a pulp and paper mill comprises a plethora of devices which transfer mechanical energy and which function to agitate, impart shear or impart turbulence to the liquid medium. Furthermore, process streams of the liquid medium may contain many compounds which possess surface active properties and which are intrinsic to the pulp source(s). This is particularly true of alkaline black liquors for which the foam generated in, for example, the washing of pulp, is difficult to regulate: alkaline black liquor contains lignin and fatty and resins acids in saponified or salt form which can serve as natural foam stabilizers. Surface active, extrinsic or process chemicals may also have been added to a given liquid process stream and can stabilize surface or dispersed foams: mention in this regard may be made of particulates, such as fillers and fines.

The regulation of foaming is required in pulp and paper mills to inter alia: minimize the loss of process chemicals; to reduce unwanted foam; to enhance water drainage from pulp mats; and, to increase the capacity of the constituent devices. Regulation can be effected by mechanical defoaming but this requires a capital outlay on equipment and continued investment in the maintenance of that equipment. Foam regulation may alternatively be effected by chemical defoaming which presents the advantage that the paper mill processes and associated equipment need not be significantly modified.

Chemical defoaming agents may function via a plurality of mechanisms. For instance, where a treatment composition comprises water insoluble, non-polar solvents, these solvents may spread on the surface of an aqueous liquid, thereby forming a new surface which causes surface foams to burst. Reactive defoaming agents in a treatment composition may react with or couple with foam stabilizing compounds to yield unstable foam products. Agents may alternatively or additionally act to reduce foam stability by increasing surface tension, reducing surface viscosity or reducing hydrogen bonding. In certain circumstances, defoaming agents may promote the breakage of foams through the formation of local, low-surface-tension points.

Whilst many chemical defoamers are known, the use of oil-in-water emulsions based on silicone is prevalent. Such emulsions typically consist of four components: i) water; ii) liquid polysiloxanes, of which dimethylpolysiloxane, methylphenylpolysiloxane and methylvinylpolysiloxane represent important examples; iii) hydrophobic silica particles; and, iv) adjunct ingredients, such as dispersants and surfactants. Whilst they are typically effective as defoamers, it can be difficult to manufacture oil-in-water emulsions of this type which possess operable stability: their manufacture is a time- and heat-intensive process, primarily because of the need to reduce the viscosity of defoamer ingredients before forming an emulsion and the sheer force required to homogenize silica in the liquid polysiloxane at a desired uniform particle size.

Where an emulsion does not possess sufficient stability, phase separation may occur which decreases defoaming efficacy and can promote fouling and deposit formation. Due to polysiloxane's hydrophobic nature, these polymers have a high affinity for any hydrophobic surface. Particularly in those circumstances where the process stream to be treated is at a high (alkaline) pH or at an elevated temperature, the reactive functionalities of the polysiloxane may condense on hydrophobic surfaces: this condensation contributes to gel formation which can accumulate in any part of the mill.

Deposition aside, a further motivation for reducing the use of polysiloxanes in defoaming treatments is derived from the fact that said oils tend to possess a low surface tension which facilitates their leakage from apparatuses within the pulp and paper mill. Furthermore, from an environmental standpoint, there is a very high energy tax associated with the synthesis of polysiloxanes which somewhat negates the benefits that polysiloxanes degrade in the environment through hydrolytic cleavage and are not derived from petroleum feedstocks.

The at least partial replacement of polysiloxanes in defoaming compositions may be beneficial and it would be felicitous if such replacement could exploit renewable feedstocks. Conversely, however, such replacement should not be deleterious to defoaming efficacy.

US 2006/0128884 A1 (Cheng et al.) discloses an oil-based composition which is used to control foam, which comprises: a) from 6 to 93 wt. % of at least one triglyceride oil or mixture of triglyceride oils; b) from 12 to 93 wt. % of a silicone; c) from 0.2 to 12.0% by weight of a triglyceride silicone stabilizing agent; d) from 0.2 to 12.0 wt. % of a hydrophobic silica; e) from 0 to 12.0 wt. % of one or more surfactants and dispersants; and, f) from 0 to 10 wt. % of one or more thickeners. The composition is characterized in that each of the triglyceride oil(s), silicone and silicone triglyceride stabilizing agents has a flash point of at least 60° C.

US2006/0128816 A1 (Cheng et al.) discloses an oil-in-water emulsion which is used to control foam, comprising: a) an oil blend comprising: at least one triglyceride oil and silicone oil and/or modified silicone product, wherein the at least one triglyceride oil is selected from the group consisting of soybean oil, corn oil, castor oil, and mixtures thereof and the weight ratio of the silicone oil and/or modified silicone product to the at least one triglyceride oil is from about 6:94 to about 90:10; b) a stabilizing agent comprising a phospholipid, included in the oil blend, c) hydrophobic particles; and, d) non-ionic surfactants and dispersants. The composition is characterized in that the oil blend, the stabilizing agent, and the surfactants and dispersants all have flash points of at least 60° C.

The triglycerides used as a partial replacement for polysiloxanes in these defoaming compositions can be provided from renewal sources, in particular plant and animal oils. The triglycerides may also present the advantages of low toxicity, low volatility, high flash point and rapid biodegradability. However, the applicability of certain triglycerides may be limited on account of their poor oxidative stability, poor hydrolytic stability and high viscosity index.

Accordingly, it is desirable to provide a defoaming composition which provides for the at least partial replacement of polysiloxanes and which provides for the use of alternative active compounds to triglycerides but which may also be derived from bio-renewable feedstocks. Furthermore, other desirable features and characteristics of the present disclosure will become apparent from the subsequent detailed description and the appended claims, taken in conjunction with the accompanying drawings and this background.

### BRIEF SUMMARY

In accordance with a first aspect of the disclosure there is provided a method of treatment of an aqueous foamable medium, the method comprising contacting the aqueous foamable medium with a defoaming agent comprising:
a) at least one C₁₂ to C₄₀ Guerbet alcohol; and/or,
b) at least one polyol ester.

The disclosure also provides a method of treatment of an aqueous process stream of a pulp and paper mill, the method comprising contacting the aqueous process stream with a defoaming agent comprising: a) at least one C₁₂ to C₄₀ Guerbet alcohol; and/or, b) at least one polyol ester.

In certain embodiments, the contact time of the defoaming agent with the aqueous process stream is from 1 to 60 minutes, for example from 1 to 30 minutes. In certain embodiments, which are not mutually exclusive of those above, the dosage of the defoaming agent contacting the aqueous process stream is from 0.1 to 1000 ppm by weight, for example 0.5 to 500 ppm by weight, based on the total weight of the aqueous process stream.

In accordance with a second aspect of the disclosure there is provided an aqueous emulsion for the treatment of a foamable aqueous medium, the treatment emulsion comprising water and, based on the weight of the emulsion:
from 1 to 20 wt. % of a first defoaming agent consisting of:
   a) at least one C₁₂ to C₄₀ Guerbet alcohol; and/or
   b) at least one polyol ester;
from 1 to 30 to wt. % of c) at least one water-immiscible liquid polysiloxane; and, from 0 to 5 wt. % of d) hydrophobic particles.

In an exemplary embodiment, the treatment emulsion comprises water and, based on the weight of the emulsion:
from 1 to 15 wt. %, for instance from 1 to 10 wt. % of a first defoaming agent consisting of:
   a) at least one C₁₂ to C₄₀ Guerbet alcohol; and/or
   b) at least one polyol ester;
from 5 to 25 wt. %, for instance from 10 to 25 wt. % of c) at least one water-immiscible liquid polysiloxane; and, from 1 to 5 wt. %, for instance from 1 to 3 wt. % of d) hydrophobic particles.

The aqueous emulsion may, in particular, be useful for the treatment of an aqueous process stream of a pulp and paper mill.

The at least one C₁₂ to C₄₀ Guerbet alcohol may, in certain embodiments, be represented by the formula:

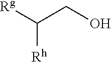

in which: R⁸ and Rh are independently C₁-C₂₀ alkyl; and,
the sum of the carbon atoms of R⁸ and Rh is from 12 to 40, for instance from 18 to 40 or from 18 to 36.

Exemplary C₁₂ to C₄₀ Guerbet alcohols, which may be used alone or in combination, include: 2-hexyl-1-decanol; 2-octyl-1-decanol; 2-octyl-1-dodecanol; 2-hexyl-1-dodecanol; 2-decyl-1-tetradecanol; 2-dodecyl-1-hexadecanol; 2-tetradecyl-1-octadecanol; and, 2-hexadecyl-1-eicosanol.

When present in the defoaming agent, the polyol ester may comprise or consist of at least one partial or complete ester of a polyol possessing from 2 to 6 hydroxyl groups per molecule with a C₅-C₃₀ saturated or unsaturated, linear fatty acid. Examples of such esters, which may be used alone or in combination, include: neopentyl glycol dioleate; trimethylolpropane dioleate; trimethylolpropane trioleate; trimethylolpropane triisostearate; trimethylolpropane tripelargonate (trimethylol trinonanoate); and, pentaerythritol tetraoleate. For instance, the use of trimethylolpropane trioleate (TMPTO), trimethylolpropane triisostearate or combinations thereof might be mentioned.

The or each polysiloxane present in part c) of the aqueous emulsion may, in certain embodiments, be exemplified by a viscosity of from 100 to 100000 mPa·s, as measured at 25° C. Independently of or additional to this exemplification, the or each polysiloxane of part c) of the aqueous emulsion may have the following formula (C₁):

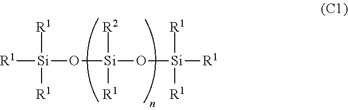

wherein: n is an integer of from 20 to 1000;
each R¹ is independently selected from C₁-C₄ alkyl or C₆-C₁₈ aryl; and,
each R² is independently selected from H, C₁-C₄ alkyl or C₆-C₁₈ aryl.

In exemplary embodiments: each R¹ is independently selected from C₁-C₂ alkyl or C₆ aryl; and, each R² is independently selected from H, C₁-C₂ alkyl or C₆ aryl. And in illustrative embodiments, each R¹ is independently selected from methyl or phenyl; and, each R² is independently selected from H, methyl or phenyl.

Part c) of the aqueous emulsion may, in certain embodiments, comprise at least one polysiloxane chosen from poly(phenylmethylsiloxane), polydimethylsiloxane, polymethylhydrosiloxane and mixtures thereof.

The hydrophobic particles included as part d) of the composition may be exemplified by a median particle size (Dv50), as measured by laser diffraction, of from 0.01 to 20 μm. Independently of or additional to this particle size exemplification, part d) of the aqueous emulsion may, in certain embodiments, comprise or consist of hydrophobic particulate silica.

Where the aspects of the disclosure are described herein as having certain embodiments, any one or more of those embodiments can, unless otherwise stated, be implemented in or combined with any one of the further embodiments, even if that combination is not explicitly described. Expressed differently, the described embodiments are not mutually exclusive unless stated as being such, and permutations thereof remain within the scope of this disclosure.

### BRIEF DESCRIPTION OF THE DRAWINGS

Various other objects, advantages, and features of the disclosure will become apparent to those skill in the art from the following discussion taken in conjunction with the appended drawings, in which like numerals denote like elements, and wherein:

FIGS. 1a to 1c depict the results of defoaming testing—as performed in a foam cell—which are obtained using a first exemplary composition in accordance with the present disclosure.

FIG. 2 depicts the results of defoaming testing—as performed in a foam cell—which are obtained using second and third exemplary compositions in accordance with the present disclosure.

FIG. 3 depicts the results of defoaming testing—as performed in a foam cell—which are obtained using third and fourth exemplary compositions in accordance with the present disclosure.

### DETAILED DESCRIPTION

The following detailed description is merely exemplary in nature and is not intended to limit the present disclosure or the application and uses thereof. Furthermore, there is no intention to be bound by any theory presented in the preceding background or the following detailed description.

### Definitions

As used herein, the singular forms “a”, “an” and “the” include plural referents unless the context clearly dictates otherwise.

The terms “comprising”, “comprises” and “comprised of” as used herein are synonymous with “including”, “includes”, “containing” or “contains”, and are inclusive or open-ended and do not exclude additional, non-recited members, elements or method steps. If used, the phrase “consisting of” is closed and excludes all additional elements. Further, the phrase “consisting essentially of’ excludes additional material elements but allows the inclusion of non-material elements that do not substantially change the nature of the invention.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

Further, in accordance with standard understanding, a weight range represented as being “from 0 to x” specifically includes 0 wt. %: the ingredient defined by said range may be absent from the material or may be present in the material in an amount up to x wt. %.

As used herein, the terms “about” or “approximately” apply to all numeric values, whether or not explicitly indicated, save for actual examples. The terminology “about” can describe values+0.1, 0.5, 1, 2, 3, 4, 5, 6, 7, 8, 9 or 10% in various embodiments.

The words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words exemplary and illustrative is intended to present concepts in a concrete fashion.

As used throughout this application, the word “may” is used in a permissive sense—that is meaning to have the potential to—rather than in the mandatory sense.

All percentages, ratios and proportions used herein are given on a weight basis unless otherwise specified.

As used herein, room temperature is 23° C. plus or minus 2° C.

The term “flash point” as used herein refers to the minimum temperature at which a liquid gives off vapor within a test vessel in sufficient concentration to form an ignitable mixture with air near the surface of the liquid. It may be determined using the appropriate active standard test methods, of which mention may be made of: ASTM D-56 Standard Method of Test for Flashpoint by Tag Closed Tester; and, ASTM D93 Standard Method of Test for Flashpoint by Pensky-Martens Closed Tester.

Viscosities of the compositions described herein are, unless otherwise stipulated, measured using the Brookfield Viscometer, Model RVT at standard conditions of 20° C. and 50% Relative Humidity (RH). The viscometer is calibrated using oils of known viscosities, which vary from 10 cps to 50,000 cps. A set of RV spindles that attach to the viscometer are used for the calibration. Measurements of the compositions are done using the No. 6 spindle at a speed of 20 revolutions per minute for 1 minute until the viscometer equilibrates. The viscosity corresponding to the equilibrium reading is then calculated using the calibration.

Unless otherwise stated, the term “particle size” refers to the largest axis of the particle. In the case of a generally spherical particle, the largest axis is the diameter.

The term “median particle size (Dv50)” as used herein, refers to a particle size corresponding to 50% of the volume of the sampled particles being greater than and 50% of the volume of the sampled particles being smaller than the recited Dv50 value. Particle size is determined herein by laser diffraction using a Particle Size Analyzer (PSA).

The degree of esterification of the polyol esters described herein may be determined via a volumetric determination of the acid value (AV), which value indicates the mass (mg) of potassium hydroxide (KOH) which is necessary to neutralize the free acids present in 1 g of said ester. The acid value can be determined in accordance DIN EN ISO 2114.

The term “defoaming agent” is used herein to encompass materials which have one or more of an antifoaming efficacy, a defoaming efficacy or a de-aeration efficacy. Antifoaming references the inhibition or prevention of foam formation. Defoaming references the decrement or removal of foams which have already been formed. De-aeration refers to the escape of entrapped air. It is noted that the efficacy of the defoaming agent in the present application is measured by its effectiveness in reducing, minimizing or removing existing foams. Those compounds and the compositions which comprise said compounds—and which are demonstrated to provide good defoaming efficacy—may be expected to also demonstrate antifoaming efficacy. However, this may not always be the case.

The term “aqueous emulsion for the treatment” and the contraction “treatment emulsion” as used herein refers to that composition which actually contacts the aqueous foamable medium, such as the aqueous process stream of a pulp or paper mill. The pH of the treatment emulsion, the temperature of the treatment emulsion and the contact time of the emulsion with a given medium are result effective variables which may be monitored either manually or automatically and adjusted in accordance with efforts to optimize defoaming performance.

As used herein, the term “dispersion” refers to a composition that contains discrete particles that are distributed throughout a continuous liquid medium.

The term “emulsion” as used herein refers to a mixture of two or more immiscible liquids held in liquid suspension: the mixture may be stabilized by the presence of emulsifiers or surfactants. Conventionally, the term “aqueous emulsion” refers to a mixture of water or an aqueous solution with an immiscible liquid-such as a liquid wax, oil or resin-held in liquid suspension. When the dispersed liquid is said wax, oil or resin and is in the discontinuous phase and the dispersion medium is in the continuous phase, this is referred to herein as an oil-in-water emulsion. Conversely, when either water or an aqueous solution is the dispersed phase and oil, wax or is the continuous phase, it is known as a water-in-oil emulsion. The present aqueous emulsions are commonly formulated as oil-in-water emulsions.

The term “foamable medium” means a non-gaseous, non-vaporous fluid material capable of serving as a matrix film for gas bubbles. The foamable medium of the present disclosure may, in certain embodiments, be exemplified in that a foam formed therein has a half-life of at least 10 seconds, for example, at least 20 seconds or at least 40 seconds: said foam half-life is the time required for half of the initial volume of foam generated in the foamable medium-when disposed within a graduated column which is held stationary at room temperature and atmospheric pressure—to revert to the bulk liquid phase. Whilst the present defoaming agent and treatment emulsion have utility in the treatment of aqueous process streams in industrial applications and, more particularly, in the treatment of aqueous process streams within pulp and paper mills, the use of said agent and said treatment emulsion on foamable pharmaceutical and cosmetic compositions, paints, coatings and adhesives is also envisaged.

As used herein, the term “aqueous process stream” refers to a liquid state stream which comprises water and to which the treatment emulsion of the present disclosure is added. In the context of a pulp and paper mill, the term is intended to encompass any stream associated therewith and includes side streams, recycle streams and effluents. In one embodiment, the process stream is an aqueous stream comprising suspended particles: as those of skill in the art will appreciate, the concentration of suspended particles in the aqueous process streams of a pulp and paper mill may vary depending on the processing stage from which they originate.

Exemplary aqueous process streams of a pulp and paper mill include the brown stock stream, green liquor, white liquor, black liquor and, for a sulfite process, the red or brown liquor. The term “green liquor” as used herein means the liquor produced from dissolving a smelt from a Kraft recovery furnace: green liquor normally comprises sodium carbonate (Na₂CO₃), sodium sulfide (Na₂S) and sodium hydroxide (NaOH) as the main compounds. The term “white liquor” as used herein means a liquor comprising sodium sulfide and sodium hydroxide as the main components. The term “black liquor” as used herein means a liquor from the Kraft process which comprises lignin degradation products and other dissolved wood components as the main components and sodium sulfide originating from a pulping process. The equivalent of the black liquor in the sulfite process is conventionally termed “brown liquor” but the terms red liquor, thick liquor or sulfite liquor may be used in the art.

The term “contact time” refers to the time period over which the treatment emulsion contacts the foamable medium. The contact time commences when at least a fraction of the treatment emulsion contacts said foamable medium, such as an aqueous process stream. In certain embodiments, the contact time may be determined by the flow rate of the aqueous process stream.

Water, for use as a (co-) solvent or diluent herein, is intended to mean water of low solids content as would be understood by a person of ordinary skill in the art. The water may, for instance, be distilled water, demineralized water, deionized water, reverse osmosis water, boiler condensate water, or ultra-filtration water. Tap water may be tolerated in certain circumstances.

As used herein “solvents” are substances capable of dissolving another substance to form a uniform solution; during dissolution neither the solvent nor the dissolved substance undergoes a chemical change. Solvents may either be polar or non-polar. The term “alcoholic solvent” encompasses such solvents which are any water-soluble mono-alcohols, diols or polyols that are liquids at 25° C. at atmospheric pressure.

The term “water-miscible liquid”, as used herein, refers to a liquid that is completely miscible with water at room temperature. In this regard, liquids may be used which are soluble, freely soluble or very soluble in water and which are exemplified by requiring ≤30 ml of water to dissolve 1 g of the named compound at room temperature.

The term “water-immiscible liquid”, as used herein refers to a liquid that forms a two-phase system with water. In this regard, liquids may be used which are slightly soluble, very slightly soluble or practically insoluble in water and which are exemplified by requiring ≥100 ml of water to dissolve 1 g of the named compound at room temperature.

As used herein, “polyol” refers to any compound comprising two or more hydroxyl groups: the term is thus intended to encompass diols, triols and compounds containing four or more-OH groups.

The term “partial ester” is used to denote a partially esterified polyol (polyhydroxy compound) in which at least one hydroxyl group is pendant or unreacted. Thus, as regards a diol, only one of the hydroxyl groups is esterified. As regards a triol, not more than two hydroxyls of the triol are esterified.

As used herein, “C₁-Cₙ alkyl” group refers to a monovalent group that contains 1 to n carbons atoms, that is a radical of an alkane and includes straight-chain and branched organic groups. As such, a “C₁-C₁₈ alkyl” group refers to a monovalent group that contains from 1 to 18 carbons atoms, that is a radical of an alkane and includes straight-chain and branched organic groups. Examples of alkyl groups include, but are not limited to: methyl; ethyl; propyl; isopropyl; n-butyl; isobutyl; sec-butyl; tert-butyl; n-pentyl; n-hexyl; n-heptyl; and, 2-ethylhexyl. In the present disclosure, such alkyl groups may be unsubstituted or may be substituted with one or more halogen. Where applicable for a given moiety (R), a tolerance for one or more non-halogen substituents within an alkyl group will be noted in the specification.

An “alkoxy group” refers to a monovalent group represented by -OA where A is an alkyl group: non-limiting examples thereof are a methoxy group, an ethoxy group and an iso-propyloxy group.

The term “C₁₋ₙalkanol” as used herein refers to compounds of the general formula ROH, where R is a C₁₋ₙ alkyl group.

As used herein, an “C₆-C₁₈ aryl” group used alone or as part of a larger moiety—as in “aralkyl group”
refers to monocyclic, bicyclic and tricyclic ring systems in which the monocyclic ring system is aromatic or at least one of the rings in a bicyclic or tricyclic ring system is aromatic. The bicyclic and tricyclic ring systems include benzofused 2-3 membered carbocyclic rings. In the present disclosure, such aryl groups may be unsubstituted or may be substituted with one or more halogen. Where applicable for a given moiety (R), a tolerance for one or more non-halogen substituents within an aryl group will be noted in the specification. Exemplary aryl groups include: C₆ aryl, such as phenyl; (C₁-C₄)alkylphenyl, such as tolyl and ethylphenyl; indenyl; naphthalenyl, tetrahydronaphthyl, tetrahydroindenyl; tetrahydroanthracenyl; and, anthracenyl.

The present materials and compositions may be defined herein as being “substantially free” of certain compounds, elements, ions or other like components. The term “substantially free” is intended to mean that the compound, element, ion or other like component is not deliberately added to the material or composition and is present, at most, in only trace amounts which will have no (adverse) effect on the desired properties of the material or composition. An exemplary trace amount is less than 1000 ppm by weight of the material or composition. The term “substantially free” encompasses those embodiments where the specified compound, element, ion, or other like component is completely absent from the material or composition or is not present in any amount measurable by techniques generally used in the art.

The term “anhydrous” as used herein has equivalence to the term “substantially free of water”. Water is not deliberately added to a given composition and is present, at most, in only trace amounts which will have no (adverse) effect on the desired properties of the composition.

### Guerbet Alcohols

As mentioned above, the treatment emulsion of the present disclosure comprises, based on the weight of the composition, from 1 to 20 wt. % of a first defoaming agent consisting of: a) at least one C₁₂ to C₄₀ Guerbet alcohol; and/or b) at least one polyol ester. For example, the treatment emulsion comprises from 1 to 15 wt. % or from 1 to 10 wt. % of: a) said at least one C₁₂ to C₄₀ Guerbet alcohol; and/or b) said at least one polyol ester. It is thereby envisaged that the first defoaming agent may: consist of said at least one C₁₂ to C₄₀ Guerbet alcohol; consist essentially of said at least one C₁₂ to C₄₀ Guerbet alcohol; or, comprise said at least one C₁₂ to C₄₀ Guerbet alcohol in combination with one or more polyol esters. Equally, the first defoaming agent may consist of said at least one polyol ester; consist essentially of said at least one polyol ester; or, comprise said at least one polyol esters in combination with one or more C₁₂ to C₄₀ Guerbet alcohols.

As used herein, the term “Guerbet alcohol” refers to a monofunctional, primary alcohol comprising at least one branching at the carbon atom adjacent to the carbon atom carrying the hydroxyl group. Chemically, Guerbet alcohols are described as 2-alkyl-1-alkanols.

The Guerbet alcohol(s) may be defined by the following general formula:

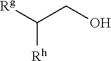

in which: R& and Rh are independently C₁-C₂₀ alkyl; and,
the sum of the carbon atoms of R& and Rh is from 12 to 40.

In an embodiment, the sum of the carbon atoms of R& and Rh is from 18 to 40 or from 18 to 36. And exemplary Guerbet alcohols having utility herein-either alone or in combination-include but are not limited to: 2-hexyl-1-decanol; 2-octyl-1-decanol; 2-octyl-1-dodecanol; 2-hexyl-1-dodecanol; 2-decyl-1-tetradecanol; 2-dodecyl-1-hexadecanol; 2-tetradecyl-1-octadecanol; and, 2-hexadecyl-1-eicosanol.

Exemplary Guerbet alcohols may be obtained commercially and mention may be made of: Isofol® 12, 14T, 16, 18T, 18E, 20, 24, 28, 32, 32T and 36 available from Sasol Chemicals; and, Pripol® 2033 (C₃₆ dimer diol), available from Jarchem Industries Inc. This aside, the Guerbet alcohols having utility herein may be directly synthesized.

The Guerbet reaction is an auto-condensation reaction in which a primary aliphatic alcohol is converted to its β-alkylated dimer alcohol with the loss of one equivalent of water: The chain length of a Guerbet alcohol produced according to the Guerbet reaction depends in principle on the primary alcohol(s) used as a starting material. A mixture of Guerbet alcohols will be obtained according to the different possible condensation reactions when a mixture of primary alcohols, which differ from each—other in their number of constituent carbon atoms, is employed as the reactant.

The Guerbet reaction is conventionally performed at an elevated temperature, often in excess of 100° C., and under conditions whereby the yielded water is removed to minimize product inhibition. A catalytic system is also required: this system should provide for dehydrogenation, aldolization, dehydration and hydrogenation and is typically composed of a strong base and either a homogenous or heterogeneous catalyst. The selection of a homogeneous or heterogeneous catalyst can be determinative of the molecular weight variance in a mixture of Guerbet alcohols but it is noted here that the use of heterogeneous catalysts can facilitate product separation. The Guerbet reaction may also be performed under an atmosphere which is supplemented with hydrogen to promote the hydrogenation of ketones and aldehydes formed as intermediate products.

As discussed above, the Guerbet alcohols of the present disclosure may be derived from bio-renewable sources. It is, for instance, envisaged that at least a fraction of the primary alcohols of the Guerbet reaction may be obtained by fermentation from biomass: instructive references on such fermentation include WO2009/079213 (Gevo Inc.); US 2017/0002387 A1 (Retsina et al.). The use of bio-renewable sources for the primary alcohol may be verified by the ratio of 14° C. to 12C isotopes.

When derived by fermentation of biomass, the primary alcohols may contain impurities, such as acids and esters. Such impurities can compromise the Guerbet reaction through neutralization of the basic compounds—such as alkali metal hydroxides or alkoxides-which are employed as co-catalysts therein. These impurities should therefore be removed by an appropriate separation or capturing method; mention may be made of solvent extraction and ion exchange in this regard. The primary alcohols may also be further pre-treated to remove water therefrom.

### a) Polyol Ester

As used herein, the term “polyol ester” references a partial or complete ester of a polyol with saturated or unsaturated fatty acid(s). For completeness, the term “unsaturated” encompasses both mono- and polyunsaturated fatty acids. There is no intention to limit the method by which such polyol esters may be obtained and, as such, the polyols esters may be derived by: acid catalyzed esterification; base catalyzed esterification; or, trans-esterification of existing esters. Each of these reactions will typically be performed under anhydrous conditions and in the presence of a stochiometric excess of polyol.

Exemplary polyol esters in accordance with the present disclosure are partial or complete esters of a polyol possessing from 2 to 6 hydroxyl groups per molecule with a C₅-C₃₀ saturated or unsaturated, linear fatty acid.

Illustrative examples of C₅-C₃₀ saturated linear fatty acids include without limitation: valeric acid, caproic acid, enanthic acid, caprylic acid, pelargonic acid, capric acid, lauric acid, myristic acid, palmitic acid, margaric acid, stearic acid, arachidic acid, behenic acid, lignoceric acid, hexacosanoic acid, octacosanoic acid and melissic acid. Illustrative examples of C₅-C₃₀ unsaturated linear fatty acids include, without limitation caproleic acid, palmitoleic acid, oleic acid, vaccenic acid, eladic acid, brassidic acid, erucic acid, nervonic acid, linoleic acid, pinoleic, linolenic acid, eleostearic acid and arachidonic acid. And illustrative examples of suitable polyols from which the polyol esters may be derived include: propane-1,2-diol; propane-1,2,3-triol; trimethylol ethane (2-(hydroxymethyl)-2-methylpropane-1,3-diol); trimethylol propane (2-ethyl-2-(hydroxymethyl) propane-1,3-diol); sucrose; sorbitol; and tripropylene glycol (2-[2-(2-hydroxypropoxy) propoxy]propan-1-ol).

In an embodiment, substituent a) comprises complete esters of: i) C₅-C₃₀ saturated or unsaturated, linear fatty acids; with ii) a polyol possessing from 2 to 6 hydroxyl groups and having a number average molecular weight of less than 200 daltons. Exemplary polyol esters according to this embodiment which have utility herein—and which may be used alone or in combination-include: neopentyl glycol dioleate; trimethylolpropane dioleate; trimethylolpropane trioleate; trimethylolpropane triisostearate; trimethylolpropane tripelargonate (trimethylol trinonanoate); and, pentaerythritol tetraoleate. Mention may, for instance, be made of trimethylolpropane trioleate (TMPTO) and trimethylolpropane triisostearate.

It will be recognized that the fatty acids, from which the polyol esters may be derived, can be sourced from renewable feedstocks, including microbial oils and the oils and fats of algal, plant and animal origin. The derivation of fatty acids from plants is well established and of large scale; moreover, the yield of fatty acids can be moderated beyond natural limits by either breeding technologies or biotechnological methods which can transfer foreign genes to crop plants. Microalgae may equally provide an important source of fatty acids; it bas been shown that fatty acid production therein can be enhanced by the selection of growth conditions-such as salt concentration, light intensity and temperature—to which the microalgae are exposed.

### c) Water-Immiscible Liquid Polysiloxane

The treatment emulsion of the present disclosure comprises, based on the weight of the emulsion, from 1 to 30 wt. % of c) at least one water-immiscible liquid polysiloxane. For example, the treatment emulsion comprises from 5 to 25 wt. % or from 10 to 25 wt. % of c) said at least one water-immiscible liquid polysiloxane. The polysiloxane may be exemplified by a viscosity of from 100 to 100000 mPa·s, for example of from 100 to 50000 m·Pas or from 100 to 20000 m·Pas as measured at 25° C.

In an embodiment, which is not intended to be mutually exclusive of the viscosity exemplification above, the or each water-immiscible liquid polysiloxane of the treatment emulsion has the following formula (C₁):

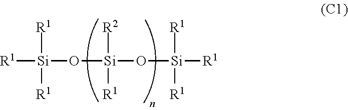

wherein: n is an integer of from 20 to 1000;
each R¹ is independently selected from C₁-C₄ alkyl or C₆-C₁₈ aryl; and,
each R² is independently selected from H, C₁-C₄ alkyl or C₆-C₁₈ aryl.

As regards compounds of Formula C₁, it is typical that: each R¹ is independently selected from C₁-C₂ alkyl or C₆ aryl; and, each R² is independently selected from H, C₁-C₂ alkyl or C₆ aryl. In exemplary polysiloxanes according to Formula CI: each R¹ is independently selected from methyl or phenyl; and, each R² is independently selected from H, methyl or phenyl. The use in the composition of one or more of poly(phenylmethylsiloxane), polydimethylsiloxane and polymethylhydrosiloxane may be mentioned.

Exemplary commercial polysiloxanes having utility in the present disclosure include: Silfar®350 and 1000, available from Wacker Chemie AG: XIAMETER™ PMX-200, available from Dow Corning; and, SF 96, available from General Electric.

### d) Hydrophobic Particles

Hydrophobic particles represent an optional component of the present emulsion and may constitute from 0 to 5 wt. %, based on the total weight of the emulsion. For example, the treatment emulsion may comprise from 1 to 5 wt. % or from 1 to 3 wt. % of said hydrophobic particles. The hydrophobic particulate material should be capable of being stably dispersed within the emulsion.

Broadly, there is no particular intention to limit the shape of the hydrophobic particles employed in the emulsion: particles that are acicular, spherical, ellipsoidal, cylindrical, bead-like, cubic or platelet-like may be used alone or in combination. Moreover, it is envisaged that agglomerates of more than one particle type may be used. However, but without intention to limit the present disclosure, the hydrophobic particles may be exemplified by at least one of the following conditions: i) a surface area of at least 50 m²/g, for example of at least 150 m²/g, as determined by multipoint Brunauer, Emmett and Teller (BET) nitrogen (N₂) adsorption; and, ii) a median particle size (Dv50), as measured by laser diffraction, of from 0.01 to 20 μm, for example from 0.1 to 20 μm or from 0.5 to 15 μm. The hydrophobic particles may have a monomodal or polymodal particle size distribution: in certain embodiments the hydrophobic particles may have either a monomodal or bimodal particle size distribution.

Exemplary hydrophobic particulate materials, which may be used alone or in combination, include: hydrophobic silica, such as hydrophobic fumed silica, hydrophobic precipitated silica and mixtures thereof; hydrophobic clays; hydrophobic sands; hydrophobic minerals; and, hydrophobic carbonaceous particles. Certain embodiments provide for the use of hydrophobic particulate silica.

The hydrophobic particulate materials may be prepared by in situ hydrophobization under heating and, optionally, catalysis. Instructive references for in situ hydrophobization include: U.S. Pat. No. 3,634,288 (Youngs); U.S. Pat. No. 4,008,173 (Davis); EP 0726086A2 (Wacker Chemie AG); and, U.S. Pat. No. 9,114,333 B2 (Burger et al.).

Such hydrophobic particulate materials may also be prepared by the subjecting initially hydrophilic particles to treatment with a hydrophobizing agent and, optionally a coupling agent, such as a titanate or zircoaluminate coupling agent. As is known in the art, said treatment may be performed in the absence of solvent (dry treatment) or in presence of a solvent (wet treatment), which solvent must be removed by, for instance, washing, filtration or distillation.

Examples of hydrophobizing agents include: halosilanes, such as C₁-C₁₂ alkylhalosilanes and C₆-C₁₈ arylhalosilanes; C₁-C₁₂ alkoxysilanes; hydrosilanes, such as C₁-C₁₂ alkylhydrosilanes and C₆-C₁₈ arylhydrosilanes; disilazanes such as tetramethyldisilazane; fatty acids having from 4 to 28 carbon atoms, such as butanoic acid, hexanoic acid, lauric acid, stearic acid, oleic acid, behenic acid; aliphatic alcohols having from 4 to 28 carbon atoms, such as n-butyl alcohol, n-amyl alcohol, n-octanol, lauryl alcohol, stearyl alcohol, behenyl alcohol; aliphatic amines having from 12 to 22 carbon atoms, such as dodecylamine, stearylamine, oleylamine; polysiloxanes, such as methylhydrogenpolysiloxanes, dimethylpolysiloxanes, C₆-C₁₀ aryl-modified polysiloxanes, C₂-C₆ alkyl-modified polysiloxanes, amino group-modified polysiloxanes; and, silicone resins, such as MQ resins comprising any combination of triorganosiloxy units (M units) and siloxy units (Q units).

Exemplary sources of hydrophobic particulate materials having utility herein include: Aerosil® R202; Aerosil® R805; Aerosil® R812; Aerosil® R812S; Aerosil® R972; Aerosil® R974; Aerosil® R8200; Aerosil® R972; Aeroxide® LE-1; Aeroxide® LE-2 and, Aeroxide® LE-3 available from Evonik Degussa GmbH. Similar hydrophobic silica particles are also available from Cabot Corporation.

### e) Additives and Adjunct Ingredients

The emulsion of the present disclosure will typically further comprise adjuvants and additives that can impart improved properties to these compositions. For instance, the adjuvants and additives might impart one or more of: emulsion stability; defoaming ability; and, improved drainage.

Included among such adjuvants and additives are: surfactants; wax; stabilizers, including UV stabilizers; biocides; and, rheological adjuvants for moderating the viscosity or thixotropic properties of the emulsions and of which examples include thickeners, fillers, solvents and non-reactive diluents. As regards any additive or adjunct material, it is typical for said material to possess a flash point of at least 60° C., for example at least 75° C.

The present emulsions may optionally comprise at least one surfactant chosen from: anionic surfactants; cationic surfactants; zwitterionic surfactants; non-ionic surfactants; and, mixtures thereof. The emulsion may, for example, comprise in toto from 0 to 10 wt. % or from 0 to 8 wt. %, of surfactants, based on the total weight of the emulsion.

In an embodiment, the surfactant(s) included in the emulsion comprise, consist essentially or consist of non-ionic surfactant. The or each surfactant included in the emulsion may, in an embodiment, be non-ionic. Non-ionic surfactants used in the emulsion may be exemplified by a number average molecular weight (Mn) of from 2000 to 20000 daltons, for example from 2000 to 10000 daltons or from 2000 to 8000 daltons. Exemplary non-ionic surfactants include: polyethylene oxides, such as PEG 300 or PEG 400; fatty alcohols; primary alcohol (C₂-C₄)alkoxylates; secondary alcohol (C₂-C₄)alkoxylates; alkylphenol (C₂-C₄)alkoxylates; alkylamino (C₂-C₄)alkoxylates; amine polyglycol condensates, such as Triton® CF-32 available from the Dow Chemical Company; polyoxy (C₂-C₃)alkylene fatty acid esters; polysorbates; sodium lauryl sulfate; sorbitan monolaurate; sorbitan monooleate; sorbitan monopalmitate; sorbitan trioleate; and, silicone surfactants, such as silicone polyether copolymers. The use of non-ionic silicone surfactants is not typical, however.

Waxes represent an optional component of the present emulsion and may constitute from 0 to 5 wt. % or from 0 to 2 wt. %, based on the total weight of the emulsion. Waxes having utility in the emulsion may typically have a softening point of from 50 to 150° C. and may include one or more of: polyethylene having a number average molecular weight (Mn) from 500 to 7500; petroleum waxes, such as paraffin wax and microcrystalline wax; synthetic waxes made by polymerizing carbon monoxide and hydrogen, such as Fischer-Tropsch wax; polyolefin waxes including functionalized polyolefin waxes of which maleated polyethylene, maleated polypropylene and maleated poly(ethylene-co-propylene) may be mentioned as examples; and, hydrogenated animal, fish or vegetable oils.

“Stabilizers” for purposes of this disclosure are understood to be materials that reduce the tendency of the emulsion to separate into two phases. When present, stabilizers may constitute in toto up to 5 wt. %, for instance from 0.1 to 2.5 wt. %, based on the total weight of the emulsion. Standard examples of stabilizers suitable for use herein include: lecithin; phospholipids; and, grafted or crosslinked silicone polymers.

One or more biocides may be present in the emulsion to control microbial growth. Biocides may constitute in toto from 0 to 1 wt. %, for instance from 0.01 to 1 wt. %, based on the weight of the emulsion. Examples of suitable biocides include but are not limited to: 5-chloro-2-methyl-4-isothiazolin-3-one; 2-methyl-4-isothiazolin-3-one; glutaraldehyde; 2,2-dibromo-3-nitrilopropionamide; 2-bromo-2-nitropropane-1,3 diol; 1-bromo-1-(bromomethyl)-1,3-propanedicarbonitrile; tetrachloroisophthalonitrile; alkyldimethylbenzyl ammonium chloride; dimethyl dialkyl ammonium chloride; poly(oxyethylene (dimethyliminio)ethylene (diemethyliminio)ethylene dichloride; methylene bisthiocyanate; 2-decylthioethanamine; tetrakishydroxymethyl phosphonium sulfate; dithiocarbamate; cyanodithioimidocarbonate; 2-methyl-5-nitroimidazole-1-ethanol; 2-(2-bromo-2-nitroethenyl) furan; beta-bromo-beta-nitrostyrene; beta-nitrostyrene; beta-nitrovinyl furan; 2-bromo-2-bromomethyl glutaronitrile; bis(trichloromethyl) sulfone, S-(2-hydroxypropyl)thiomethanesulfonate; tetrahydro-3,5-dimethyl-2H-1,3,5-hydrazine-2-thione; 2-(thiocyanomethylthio) benzothiazole; 2-bromo-4′-hydroxyacetophenone; 1,4-bis(bromoacetoxy)-2-butene; bis(tributyltin) oxide; copper sulfate; (2-tert-butylamino)-4-chloro-6-(ethylamino)-s-triazine; dodecylguanidine acetate; dodecylguanidine hydrochloride; coco alkyldimethylamine oxide; n-coco alkyltrimethylenediamine; tetra-alkyl phosphonium chloride; 7-oxabicyclo[2.2.1]heptane-2,3-dicarboxylic acid; 2-(4-thiazolyl)-benzimidazole; orthophenylphenol; 6-ethoxy-1,2-dihydro-2,2,4-trimethyl quinoline; and, 4,5-dichloro-2-n-octyl-4-isothiazoline-3-one.

Thickeners represent an optional component of the present emulsion and may constitute from 0 to 5 wt. % or from 0 to 2 wt. %, based on the total weight of the emulsion. Exemplary thickeners include but are not limited to: cellulosic thickeners and their derivatives; natural gums, such as guar gum, karaya gum, locust bean gum, carrageenan, tragacanth gum and xanthan gum; starches; stearates; fatty alcohols; hydrophobically modified alkali-soluble emulsion polymers (HASE); hydrophobically modified urethane-ethoxylate resins (HEUR); and, acrylic acid polymers and cross-polymers. The use of cellulosic thickeners and their derivatives may be mentioned, of which examples include: carboxymethyl hydroxyethylcellulose; cellulose, hydroxybutyl methylcellulose; hydroxyethylcellulose; hydroxypropylcellulose; hydroxypropyl methyl cellulose; methylcellulose; microcrystalline cellulose; and, sodium cellulose sulfate.

The presence of co-solvents and non-reactive diluents in the emulsions of the present disclosure is also not precluded where this can usefully moderate the viscosities thereof. When present, the co-solvent(s) or diluent may commonly comprise or consist of a non-polar, water-immiscible compound. Such a compound may be chosen from: alkanes (R—H); cyclic alkanes; branched alkanes; aromatics (Ar—H); alkyl halides (R—X); and, mixtures thereof. Exemplary but non-limiting non-polar, water-immiscible solvents which may be used alone or in combination, include n-pentane, n-hexane, cyclohexane, n-heptane, isooctane, trimethylpentane, toluene, xylene and benzene.

The above aside, it is typical that said solvents and non-reactive diluents constitute in toto less than 10 wt. %, for example less than 5 wt. % or less than 2 wt. %, based on the total weight of the emulsion.

### Illustrative Embodiments of the Treatment Emulsion

In a first illustrative embodiment, there is provided an aqueous emulsion for the treatment of an aqueous process stream in a pulp and paper mill, the treatment emulsion comprising water and, based on the weight of the emulsion:
from 1 to 15 wt. % of a first defoaming agent consisting of:
   a) at least one C₁₂ to C₄₀ Guerbet alcohol represented by the formula:

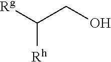

wherein: R& and Rh are independently C₁-C₂₀ alkyl; and,
   the sum of the carbon atoms of R⁸ and Rh is from 12 to 40;
from 5 to 25 wt. % of c) at least one water-immiscible liquid polysiloxane having the formula (C₁)

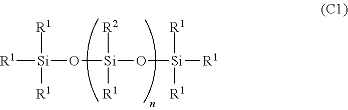

wherein: n is an integer of from 20 to 1000;
   each R¹ is independently selected from C₁-C₄ alkyl or C₆-C₁₈ aryl; and,
   each R² is independently selected from H, C₁-C₄ alkyl or C₆-C₁₈ aryl; and,
from 1 to 5 wt. % of d) hydrophobic particles, wherein said hydrophobic particles have a median particle size (Dv50), as measured by laser diffraction, of from 0.01 to 10 μm.

In a second illustrative embodiment, there is provided an aqueous emulsion for the treatment of an aqueous process stream in a pulp and paper mill, the treatment emulsion comprising water and, based on the weight of the emulsion:
from 1 to 15 wt. % of a first defoaming agent consisting of:
   a) at least one partial or complete ester of a polyol possessing from 2 to 6 hydroxyl groups per molecule and having a number average molecular weight of less than 200 daltons with a C₅-C₃₀ saturated or unsaturated, linear fatty acid;
from 5 to 25 wt. % of c) at least one water-immiscible liquid polysiloxane having the formula (C₁)

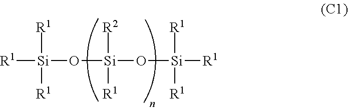

wherein: n is an integer of from 20 to 1000;
   each R¹ is independently selected from C₁-C₄ alkyl or C₆-C₁₈ aryl; and,
   each R² is independently selected from H, C₁-C₄ alkyl or C₆-C₁₈ aryl; and,
from 1 to 5 wt. % of d) hydrophobic particles, wherein said hydrophobic particles have a median particle size (Dv50), as measured by laser diffraction, of from 0.01 to 10 μm.

As regards this second illustrative embodiment, the first defoaming agent may, in certain examples, comprise or consist of trimethylolpropane trioleate (TMPTO).

### Methods and Applications

To form the defined emulsions, the parts are brought together and mixed. It is important that the mixing homogenously distributes the ingredients within the emulsion: thorough and effective mixing can be determinative of a homogeneous distribution of any constituent particulate materials. The mixing is thus not usually conducted by hand but is instead performed using either a static mixer, dynamic mixer, colloid mill, rotor-stator homogenizer or an ultrasonic probe. Whilst the order in which the constituent ingredients are mixed and the temperature of mixing may not typically be germane, it may of course be varied to ensure the homogeneity of the mixture. The mixing procedure may, in some embodiments, be carried out at reduced pressure to prevent incorporation of air which is present, for example, in highly disperse fillers.

If necessary, the treatment emulsion may be prepared well in advance of its application. However, in an interesting alternative embodiment, a concentrated treatment composition may first be obtained by mixing components with only a fraction of the water that would be present in the treatment emulsion as utilized: the concentrated treatment composition may then be diluted with the remaining water shortly before its contacting the foamable medium or process stream. It is considered that such concentrated compositions may be prepared and stored as either single-package concentrates—that can be converted by dilution with water only- or as multi-part concentrates, two or more of which must be combined and diluted to form a complete working emulsion according to the disclosure. Any dilution can be effected simply by the addition of water, customarily deionized and/or demineralized water, under mixing. The emulsion might equally be prepared within a rinse stream whereby one or more streams of the concentrate(s) is injected into a continuous stream of water.

In one embodiment, the treatment emulsions disclosed herein are added to or dosed into the aqueous foamable medium. The means of addition or dosing is not intended to be limited and indeed may be manual or automatic. Further, the emulsion may be dosed continuously or periodically as a batch process. The practitioner will be able to determine an appropriate dosage and contact time depending on the foamable medium being treated, where necessary employing trial and error. It is envisaged that contact times of less than 60 minutes will be typical.

As regards the treatment of one or more process streams of the pulp and paper processing system, exemplary addition or dosing methods include: the use of vat dilution lines; spraying, including curtain spraying, compressed air spraying and electrostatic spraying; introduction into storage towers or tanks which feeds a given process stream, such as the fresh water tank, warm water tank and shower water tank; introduction into the headbox; and, mixing of a stream of the emulsion with the process stream. In the lattermost mixing operation, the emulsion may be provided via a short loop which conjoins at an angle to the vessel carrying the process stream.

The contact time of the emulsion with a process stream may, in certain embodiments, be from 1 to 60 minutes, for example from 1 to 40 minutes of from 1 to 20 minutes.

The treatment emulsions according to the present disclosure are commonly added to the aqueous process stream such that the first defoaming agent is present in an amount of from 0.1 to 1000 ppm by weight, based on the total weight of the process liquid to be defoamed. For example, the treatment emulsion may be added such that the first defoaming agent is present in an amount of from 0.5 to 500 ppm by weight or from 1 to 200 ppm by weight, based on the total weight of the aqueous process stream. In an alternative expression, which is not intended to mutually exclusive of that given before, the treatment emulsion may be added such that the first defoaming agent is present in an amount of from 0.5 to 500 μl or from 1 to 200 μl per litre of the aqueous process stream.

The following examples are illustrative of the present invention and are not intended to limit the scope of the invention in any way.

### EXAMPLES

The following materials were employed in the Examples:
Isofol® 20:2-octyl-1-dodecanol, available from Sasol Chemicals.
TMPTO: Trimethylolpropane trioleate, available from Sigma Aldrich.
Nopcomaster ENA 2000: Silicone/iso-propyl myristate (IPM) based defoamer, available from Solenis.

The following test procedure was conducted to evaluate the defoaming emulsions.

Emulsion Preparation Procedure: The aqueous emulsions as described below were either provided as water-dilutable commercial products or were prepared in situ. The addition of diluent (water) and any ingredient was conducted under stirring. Phase separation of the emulsions—as determined by visual observation—was not permitted prior to the use of the emulsions.

### Foam Cell Test Procedure:

i) To elevate the foam cell testing equipment (7 cm diameter; 45 cm height) to a temperature at or near the testing temperature (80-85° C.), a pre-heated volume (500-800 ml) of either process liquor or water was introduced into all lines thereof by pumping. The pump used was not run continuously. The introduced liquid was allowed to sit in the lines for from 30 to 60 seconds. The lines were then drained and re-filled with from 500 to 600 ml of fresh black liquor.
ii) A re-circulation pump was started to build the foam height of the introduced liquor. When required, the re-circulation rate was adjusted to achieve a foam level of from 25 to 40 cm (10-16 inches) within a duration of from 10 to 20 seconds. The foam rise rate will vary depending on the qualities of the black liquor. In order to obtained an effective fast rise rate, it was necessary to prevent excessive temperature loss of the liquor and to avoid both pump cavitation and erratic flow of the liquor. The selected level of foam is designated as FH₀ for all subsequent runs.
iii) At t=0, 25 μl of the control defoaming emulsion was injected into the filtrate stream at the top of the foam cell using a micropipette: the pump remains running at this time. Care was taken to inject the treatment emulsion directly into the liquor stream but not to push the micropipette through the liquor: defoaming emulsion dropped onto the top of the foam head or only into the edge of the stream would result in inconsistent results.
iv) Upon injection of the defoaming emulsion, a timer or stopwatch was immediately started (t=0) and the foam level was recorded to the nearest centimeter at intervals of 5 seconds up to 125 seconds, subject to the proviso that the foam level has not exceeded the initial level (FH₀). Upon initial injection of the defoaming emulsion, the foam level declines. The percentage knockdown (%) of the foam is determined based on the formula: 100*(FH₀−FHₘᵢₙ)/FH₀ wherein FHₘᵢₙ is the minimum height of the foam recorded in the first 30 seconds after injection of the defoamer (t=30). The time at which that minimum is attained is recorded (tₘᵢₙ).
v) Either at 125 seconds (t=125) or at the recorded time when the foam reaches hits its starting level, the pump was turned off. Various parameters characterizing foam persistence may be determined. The foam persistence (P¹) reflects the rate of increase of foam height after the foam knockdown up to t=125s and was determined based on the formula (FH₁₂₅−FHₘᵢₙ)/(125−tₘᵢₙ) wherein FH₁₂₅ is the foam height recorded at t=125 seconds. Persistence (P², s) may also be given herein below as the time required for the foam to reach its maximum height (FHₘₐₓ) after foam collapse due to the addition of the defoamer. Persistence (P³, %) may also be given below as a relative deviation from the control formulation (100%) of the integrated area beneath a curve of measured foam height versus time in the range from 75 to 125 seconds (75≤t≤125).
vi) Following the pump being turned off, timing was continued until the earliest of 60 seconds or the time for the foam to dissipate to the liquor surface: the dissipation time (foam collapse) was recorded where applicable, together with any observations on foam stability, the final foam level and the presence or absence of deposits on the walls of the testing equipment.
vii) In those circumstances where FHₘᵢₙ for the control defoamer was not less than 15 cm in the foam cell, the dosing of that defoaming emulsion was adjusted upwards and the knockdown test repeated. Conversely, where FHₘᵢₙ for the control defoamer was less than 15 cm but the foam remained below the 15 cm mark after 60 seconds (t=60), the dosing of the defoamer was adjusted downward and the knockdown test repeated. This adjustment is necessary to ensure that product distinctions can be made relative to the control product.
viii) Following the testing with the control defoamer, the liquor was drained from the unit. The above testing procedure-commencing from step of pre-heating the unit—was repeated for each defoaming emulsion to be tested. In those circumstances where the time to yield the initial foam height exceeded 30 seconds, the test was aborted and the unit was re-cleaned. If, upon repetition, the build time continues to be an issue, this was deemed to be indicative that the quality of the liquor had changed and that the testing cycle must be repeated.
ix) The source of the black liquor and the flow rate of that liquor through the unit, as established by the pump, should not differ from that used for the control defoamer. The product dosing for the tested defoaming emulsions should be adjusted to achieve equivalent dosing of actives relative to the established dosing declared for the control product.
x) Each defoaming emulsion to be screened was run in triplicate in randomized order. The final data (knockdown; persistence; dissipation time) for each emulsion was then averaged and, where applicable, tabulated herein below.

### Example 1

Emulsions were prepared in accordance with Table 1 hereinbelow: the stated percentages are by weight, based on the total weight of the emulsion.

TABLE 1

| | Control 1 | Formulation 1 |
|---|---|---|
| Ingredient | (wt. %) | (wt. %) |
| Silicones | 19.8 | 15.2 |
| Emulsifier | 3.3 | 3.3 |
| Adjuncts | 4.3 | 4.3 |
| Water | 72.6 | 72.6 |
| TMPTO | | 4.6 |

For each of the Control Formulation and Formulation 1, three foam cell tests (I, II, III) were performed.
I: In this first test, defoaming efficacy of each formulation was evaluated using black liquor from Mill 1, US Southern Softwood at a test temperature of 85° C.: the dosage of the emulsions was 80 μl per litre of the treated liquor.
II: In this second test, defoaming efficacy of each formulation was evaluated using black liquor from Mill 2, US Southern Softwood at a test temperature of 75° C.: the dosage of the emulsions was 80 μl per litre of the treated liquor.
III: In the third test, the defoaming efficacy of each formulation was evaluated using US Northern Softwood at a test temperature of 75° C.: the dosage of the emulsions was 60 μl per litre of the treated liquor.

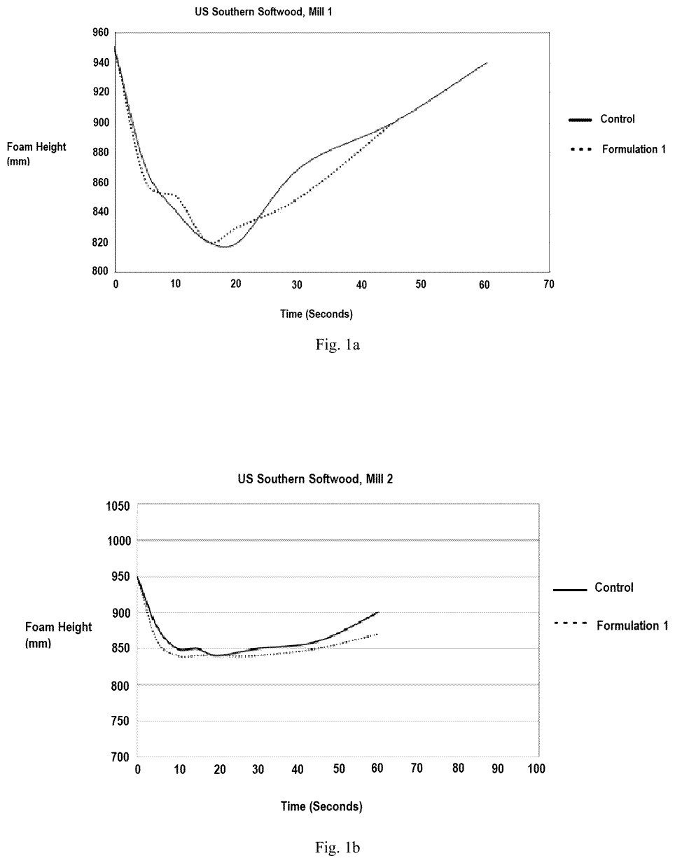

The results of the foam cell testing (I, II, III) of these formulations are illustrated in FIGS. 1a (I), 1b (II) and 1c (III) respectively, as appended hereto. In the first and second tests, it is evident that Formulation 1 demonstrated near equivalent (I) or superior (II) defoaming efficacy, throughout the test procedure, as compared to the Control formulation. In the third test, Formulation 1 demonstrated much improved initial performance (knockdown) as compared to the Control Formulation.

### Example 2

Emulsions were prepared in accordance with Table 2 herein below.

TABLE 2

| | Control | Formula- | Formula- | Formula- | Formula- |
|---|---|---|---|---|---|
| | 2 | tion 2 | tion 3 | tion 4 | tion 5 |
| Ingredient | (wt. %) | (wt. %) | (wt. %) | (wt. %) | (wt. %) |
| Silicones | 14.3 | 14.3 | 13.6 | 12.8 | 11.5 |
| Emulsifier | 6.8 | 6.8 | 6.8 | 6.8 | 6.8 |
| Adjuncts | 2.6 | 2.6 | 2.6 | 2.6 | 2.6 |
| Water | 76.3 | 72.3 | 75.3 | 73.8 | 71.1 |
| TMPTO | | 4.0 | 1.7 | 4.0 | 8.0 |

The foam cell test procedure detailed above was performed using pine black liquors from Brazil at a temperature of 85° C.: the dosage of the active defoaming agent(s) was 13 ppm by weight, based on the weight of the treated liquor. The test results are given in Table 3 herein below:

TABLE 3

| | Control | Formula- | Formula- | Formula- | Formula- |
|---|---|---|---|---|---|
| Parameter | 2 | tion 2 | tion 3 | tion 4 | tion 5 |
| Knockdown | 58.9 | 67.2 | 58.3 | 61.7 | 61.7 |
| (%) | | | | | |
| Persistence | 410 | 650 | 610 | 580 | 560 |
| (sec) | | | | | |

### Example 3

Emulsions were prepared in accordance with Table 4 herein below.

TABLE 4

| | Control 3 | Formula- | Formula- | Formula- |
|---|---|---|---|---|
| | ENA2000 | tion 6 | tion 7 | tion 8 |
| Ingredient | (wt. %) | (wt. %) | (wt. %) | (wt. %) |
| Silicones | 21.1 | 21.1 | 20.1 | 20.6 |
| Isopropyl myristate | 5.0 | 0.0 | 0.0 | 0.0 |
| Emulsifiers | 7.3 | 7.3 | 7.3 | 7.3 |
| Adjuncts | 1.6 | 0.85 | 0.85 | 1.2 |
| Water | 65.0 | 64.75 | 65.75 | 65.9 |
| TMPTO | 0.0 | 6.0 | 6.0 | 5.0 |

The foam cell test procedure detailed above was performed using Mercer Rosenthal Softwood Black liquor at a temperature of 85° C.: the dosage of the active defoaming agent(s) was 50 ppm by weight, based on the weight of the treated liquor. The test results are given in Table 5 herein below:

TABLE 5

| | Control | Formula- | Formula- | Formula- |
|---|---|---|---|---|
| Parameter | 3 | tion 6 | tion 7 | tion 8 |
| Knockdown | 100 | 100 | 98 | 97 |
| (%) | | | | |
| Persistence (%) | 100 | 190 | 95 | 188 |

### Example 4

Emulsions were prepared in accordance with Table 6 herein below.

TABLE 6

| | Control 3 | Formulation 9 | Formulation 10 |
|---|---|---|---|
| Ingredient | (wt. %) | (wt. %) | (wt. %) |
| Silicones | 21.1 | 21.1 | 21.1 |
| Isopropyl | 5.0 | | |
| myristate | | | |
| Emulsifiers | 7.3 | 7.3 | 7.3 |
| Adjuncts | 1.6 | 1.6 | 1.6 |
| Water | 65.0 | 65.0 | 65.0 |
| Isofol ® 20 | | | 5.0 |
| TMPTO | | 5.0 | |

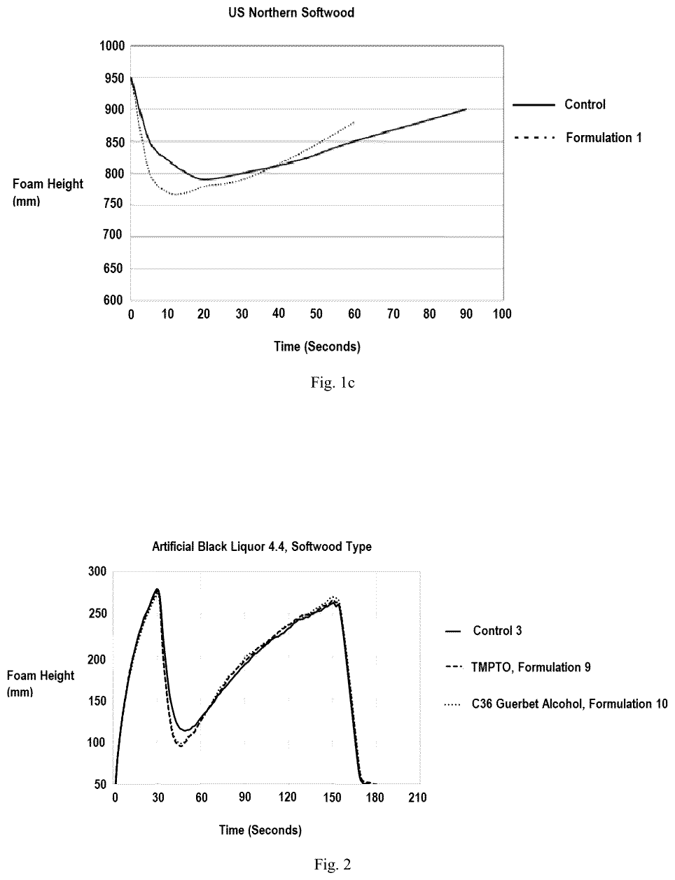

The foam cell test procedure detailed above was performed using Artificial Black Liquor 4.4, Softwood Type at a temperature of 85° C.: the dosage of the emulsions was 50 μl per litre of the treated liquor. The results of the foam cell testing of these formulations are illustrated in FIG. 2 as appended hereto. It is evident from this Figure that both TMPTO and C₃₆ Guerbet alcohol may replace iso-propyl myristate as an active defoaming agent without compromising the performance of the emulsions. The presence of the TMPTO and the C₃₆ Guerbet alcohol (Isofol®20) appears to contribute to improved knockdown performance.

### Example 5

Emulsions were prepared in accordance with Table 7 herein below.

TABLE 7

| | Control 4 | Formulation 1 | Formulation 11 |
|---|---|---|---|
| Ingredient | (wt. %) | (wt. %) | (wt. %) |
| Silicones | 19.8 | 15.2 | 15.2 |
| Emulsifier | 3.3 | 3.3 | 3.3 |
| Adjuncts | 4.3 | 4.3 | 3.3 |
| Water | 72.6 | 72.6 | 72/6 |
| Isofol ® 20 | | | 4.6 |
| TMPTO | | 4.6 | |

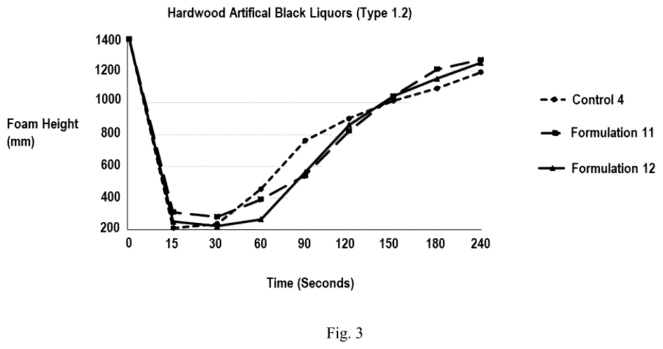

The foam cell test procedure detailed above was performed using Artificial Black Liquor 1.2, Hardwood Type at a temperature of 82° C.: the dosage of the emulsions was 40 ppm by weight, based on the weight of the treated liquor. The results of the foam cell testing of these formulations are illustrated in FIG. 3 as appended hereto: the addition of either TMPTO or 2-octyl-1-dodecanol yields improved persistency in defoaming.

It should be understood that various changes and modifications to the exemplary embodiments described herein will be apparent to those skilled in the art. Such changes and modifications can be made without departing from the spirit and scope of the present subject matter and without diminishing its intended advantages. It is therefore intended that such changes and modifications be covered by the appended claims. Also, it should be appreciated that the features of the dependent claims may be embodied in the compositions and methods of each of the independent claims.

Many modifications to and other embodiments of the invention set forth herein will come to mind to one skilled in the art to which these inventions pertain, once having the benefit of the teachings in the foregoing descriptions and associated drawings. Therefore, it is understood that the inventions are not limited to the specific embodiments disclosed, and that modifications and other embodiments are intended to be included within the scope of the appended claims.

What is claimed is:

1. A method of treatment of an aqueous foamable medium, the method comprising contacting the aqueous foamable medium with a defoaming agent comprising:
a) at least one C₁₂ to C₄₀ Guerbet alcohol; and/or,
b) at least one polyol ester.

2. The method according to claim 1, wherein the aqueous foamable medium is a process stream of a pulp and paper mill.

3. The method according to claim 2, wherein the contact time of the defoaming agent with the aqueous process stream is from 1 to 60 minutes.

4. The method according to claim 2, wherein the dosage of the defoaming agent contacting the aqueous process stream is from 0.1 to 1000 ppm by weight, based on the total weight of the aqueous process stream.

5. The method according to claim 4, wherein the dosage of the defoaming agent contacting the aqueous process stream is from 0.5 to 500 ppm by weight, based on the total weight of the aqueous process stream.

6. An aqueous emulsion for the treatment of an aqueous foamable medium, the treatment emulsion comprising water and, based on the weight of the emulsion:
from 1 to 20 wt. % of a first defoaming agent consisting of:
a) at least one C₁₂ to C₄₀ Guerbet alcohol; and/or
b) at least one polyol ester;
from 1 to 30 to wt. % of c) at least one water-immiscible liquid polysiloxane; and,
from 0 to 5 wt. % of d) hydrophobic particles.

7. The treatment emulsion according to claim 6 comprising water and, based on the weight of the emulsion:
from 1 to 15 wt. % of a first defoaming agent consisting of:
a) at least one C₁₂ to C₄₀ Guerbet alcohol; and/or
b) at least one polyol ester;
from 5 to 25 wt. % of c) at least one water-immiscible liquid polysiloxane; and,
from 1 to 5 wt. % of d) hydrophobic particles.

8. The treatment emulsion according to claim 6, wherein the first defoaming agent comprises or consists of at least one C₁₂ to C₄₀ Guerbet alcohol having the formula: 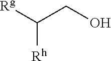
in which: R⁸ and Rh are independently C₁-C₂₀ alkyl; and,
the sum of the carbon atoms of R⁸ and Rh is from 12 to 40.

9. The treatment emulsion according to claim 8, wherein the sum of the carbon atoms of R⁸ and Rh is from 18 to 40.

10. The treatment emulsion according to claim 8, wherein the sum of the carbon atoms of R⁸ and Rh is from 18 to 36.

11. The treatment emulsion according to claim 8, wherein the first defoaming agent comprises or consists of at least one C₁₂ to C₄₀ Guerbet alcohol chosen from: 2-hexyl-1-decanol; 2-octyl-1-decanol; 2-octyl-1-dodecanol; 2-hexyl-1-dodecanol; 2-decyl-1-tetradecanol; 2-dodecyl-1-hexadecanol; 2-tetradecyl-1-octadecanol; 2-hexadecyl-1-eicosanol; and, mixtures thereof.

12. The treatment emulsion according to claim 6, wherein the first defoaming agent comprises or consists of at least one partial or complete ester of a polyol possessing from 2 to 6 hydroxyl groups per molecule with a C₅-C₃₀ saturated or unsaturated, linear fatty acid.

13. The treatment emulsion according to claim 6, wherein the first defoaming agent comprises or consists of at least one polyol ester chosen from: neopentyl glycol dioleate; trimethylolpropane dioleate; trimethylolpropane trioleate; trimethylolpropane triisostearate; trimethylolpropane tripelargonate (trimethylol trinonanoate); pentaerythritol tetraoleate; and, mixtures thereof.

14. The treatment emulsion according to claim 6, wherein the first defoaming agent comprises or consists of trimethylolpropane trioleate (TMPTO) and/or trimethylolpropane triisostearate.

15. The treatment emulsion according to claim 6, wherein the or each polysiloxane of part c) has a viscosity of from 100 to 100000 mPa·s, as measured at 25° C.

16. The treatment emulsion according to claim 6, wherein the or each polysiloxane of part c) has the following formula (C₁): 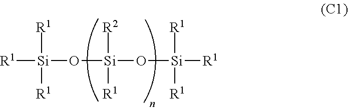
wherein: n is an integer of from 20 to 1000;
each R¹ is independently selected from C₁-C₄ alkyl or C₆-C₁₈ aryl; and,
each R² is independently selected from H, C₁-C₄ alkyl or C₆-C₁₈ aryl.

17. The treatment emulsion according to claim 16, wherein in Formula C₁:
each R¹ is independently selected from C₁-C₂ alkyl or C₆ aryl; and,
each R² is independently selected from H, C₁-C₂ alkyl or C₆ aryl.

18. The treatment emulsion according to claim 16, wherein in Formula C₁:
each R¹ is independently selected from methyl or phenyl; and,
each R² is independently selected from H, methyl or phenyl.

19. The treatment emulsion according to claim 16, wherein part c) comprises at least one polysiloxane chosen from poly(phenylmethylsiloxane), polydimethylsiloxane, polymethylhydrosiloxane and mixtures thereof.

20. The treatment emulsion according to claim 6, wherein part d) comprises or consists of hydrophobic particulate silica.
